(19) United States
(12) Patent Application Publication
(10) Pub. No.: US 2006/0056616 A1
(43) Pub. Date: Mar. 16, 2006

(54) Hospital telephone and device controller

(76) Inventor: Richard H. Heimbrock, Cincinnati, OH (US)

Correspondence Address: BARNES & THORNBURG, 11 SOUTH MERIDIAN, INDIANAPOLIS, IN, 46204, US

(21) Appl. No.: 11/216,202

(22) Filed: Aug. 31, 2005

Related U.S. Application Data
(60) Provisional application No. 60/608,979, filed on Sep. 10, 2004.

(51) Int. Cl. H04M 1/00; H04M 9/00

(52) U.S. Cl. 379/428.01

(57) ABSTRACT

A hand-held pendant operating as a telephone and a controller of one or more functions of a patient-support apparatus is disclosed. The hand-held pendant has a complementary holster which mounts in the siderail of the patient-support apparatus and serves to retain the hand-held pendant. The hand-held pendant has two sides, one functioning as a telephone and the other as a controller for one or more functions of a patient-support apparatus.

### RELATED APPLICATIONS

This application claims the benefit, under 35 U.S.C. § 119(e), of U.S. Provisional Patent Application Ser. No. 60/608,979 filed Sep. 10, 2004 which is hereby incorporated by reference herein in its entirety.

### BACKGROUND OF THE INVENTION

The present disclosure relates to a pendant to be used in a hospital or other healthcare facility room for a patient to control various devices and equipment in the room or to communicate externally from the room. More particularly, the present disclosure relates to a pendant operating as both a controller and telephone with improved positioning so that it is readily accessible by the patient.

Various types of controllers and communication devices are known in the healthcare environment. Controllers coupled to hospital beds, bedside cabinets, and walls are known. Communication devices such as phones and nurse call apparatus are known to be coupled to hospital beds, bedside cabinets, and walls as well. Controllers may control any of a number of devices including the bed, mattress, lighting, television, radio, heating or air conditioning. Communications devices may include nurse call systems, telephones, and intercoms which are separate from controllers for bed functions.

### SUMMARY OF THE INVENTION

The present invention comprises one or more of the features recited in the appended claims and/or the following features which, alone or in any combination, may comprise patentable subject matter:

In one embodiment of the invention a patient-support apparatus comprises a frame, a patient-support deck supported on the frame, a mattress supported on the patient-support deck, and a siderail coupled to the frame adjacent the mattress. The patient-support apparatus may further comprise a holster and a pendant supported by the holster. The pendant may function as both a telephone and a controller to receive user inputs that control at least some of the functions of the patient-support apparatus.

The holster may be attached to the siderail and moveable to a plurality of positions. The holster may be configured to hold the pendant until the pendant is removed from the holder. The pendant may have a cord connecting the pendant to an interface for a patient-support apparatus control and a telephone system. The cord may pass through the holster with some slack being stored in the holster. The cord may be retracted into the holster by a clock spring mechanism.

In another embodiment, the holster may be coupled to a support structure. The support structure may be coupled to the patient-support apparatus or to a piece of furniture in the room. The support structure may receive the holster and be movable by a user to a plurality of positions. In still another embodiment, the holster may be coupled to a support structure that is attached to a structure in the patient room such as a wall or the ceiling. The support structure may include a cord coupling the pendant to the patient-support apparatus. The cord may pass through an arm of the support structure.

The pendant may be substantially waterproof. The pendant may further comprise a disposable sanitary cover. The pendant may have two sides, with a first side having a user interface dedicated to the functions of the patient-support apparatus and a second side being dedicated to a user interface for a telephone. Alternatively, the pendant may further comprise a touchscreen user interface.

In some embodiments, the pendant may further comprise a wireless connection to the patient-support apparatus. In other embodiments, the retraction of the cord may be accomplished with the use of a weight on the cord outboard of the siderail which tends to pulls the cord through the holster when the user stows the pendant. In one embodiment, the holster is omitted and the pendant is configured to couple directly to the siderail for storage.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a patient-support apparatus showing the patient side of a holster coupled to a siderail, with a hand-held pendant stowed in the holster;

FIG. 2 is a perspective view of a patient-support apparatus showing the outboard side of a holster coupled to a siderail, with a weighted cord used to retract a hand-held pendant cord;

FIG. 3A is a perspective view of the patient side of a holster with a hand-held pendant extending from the holster;

FIG. 3B is a perspective view of the backside of the holster of FIG. 3A with a hook in an extended position;

FIG. 4 is a front view of a hand-held pendant showing buttons useable to control functions of a patient-support apparatus;

FIG. 5 is a side view of the hand-held pendant of FIG. 4;

FIG. 6 is a back view of the hand-held pendant of FIG. 4 showing buttons useable to control the telephone functions of the pendant;

FIG. 7 is a perspective view of an alternative embodiment of a holster coupled to a flexible member of a support arm;

FIG. 8 is a perspective view of a hospital bed with a support structure coupled to the bed by a mounting bar, the support structure being movable along the mounting bar between a first position (in solid) and a second position (in phantom), and the support structure includes a flexible arm movable to support a holster and a hand-held pendant carried by the holster in a variety of positions;

FIG. 9 is a perspective view of the support structure of FIG. 8 coupled to a chair instead of a bed;

FIG. 10 is a perspective view of the support structure of FIG. 8 coupled to an overbed table instead of a bed;

FIG. 11 is a perspective view of another embodiment of a support structure mounted to a horizontal track member that is mounted to a room wall;

FIG. 12 is a perspective view showing an alternative embodiment of a support structure having an articulated arm mounted to a patient room wall, a display coupled to an end of the articulated arm, a holster coupled to the display screen, and a pendant carried by the holster;

FIG. 13 is a perspective view of an alternative embodiment of a hand-held pendant wherein the hand-held pendant has a touchscreen display;

FIG. 14 is a screen shot of the pendant of FIG. 13 showing the touchscreen configured to control telephone functions of the pendant;

FIG. 15 is a screen shot of the pendant of FIG. 13 showing the touchscreen configured as an interactive menu;

FIG. 16 is a screen shot of the pendant of FIG. 13 showing the touchscreen configured to operate as an input device to alter television channel and volume settings;

FIG. 17 is a perspective view of a patient-support apparatus with another embodiment of a pendant stowed directly into the opening of a siderail and a first side of the pendant facing toward a patient and having buttons to control functions of the patient-support apparatus;

FIG. 18 is a perspective view of a second side of the pendant of FIG. 17 showing the pendant having buttons useable to control telephone functions of the pendant; and

FIG. 19 is a perspective view, partly diagrammatic, of a hospital room illustrating a hand-held pendant wirelessly communicating with a telephone system and with other devices.

### DETAILED DESCRIPTION OF THE DRAWINGS

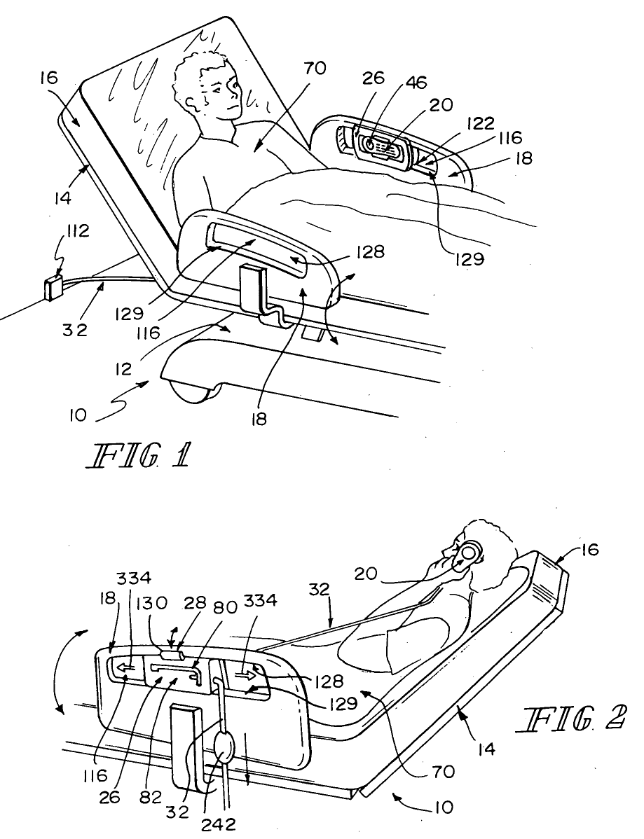

A hand-held pendant 20 shown in FIG. 1 functions as both a telephone and a controller to receive inputs from a user to control one or more functions of a patient-support apparatus 10. The patient-support apparatus 10 has a frame 12, a patient-support deck 14, a mattress 16, a pair of siderails 18, and a holster 26 in which hand-held pendant 20 is carried. Patient-support deck 14 is located above frame 12 and supports mattress 16 which is placed on top of patient-support deck 14. A patient 70 lies on mattress 16. Siderails 18 are adjacent to mattress 16 and are coupled to frame 12 for movement between raised positions, shown in FIG. 1, and lowered positions (not shown) down away from mattress 16 when not in use.

Referring now to FIGS. 1 and 2, holster 26 is couples to siderail 18. Holster 26 includes a releasable latch 28 which retains holster 26 in the siderail. Latch 28 is spring loaded to provide positive engagement between holster 26 and siderail 18 until released by a user. Pendant 20 couples to holster 26 by snap-fit. A cord 32 couples pendant 20 to patient-support apparatus 10. Cord 32 extends from holster 26 to pendant 20 through a retraction mechanism 76. When pendant 20 is stowed in holster 26, cord 32 spools into retraction mechanism 76 so as to remove any slack.

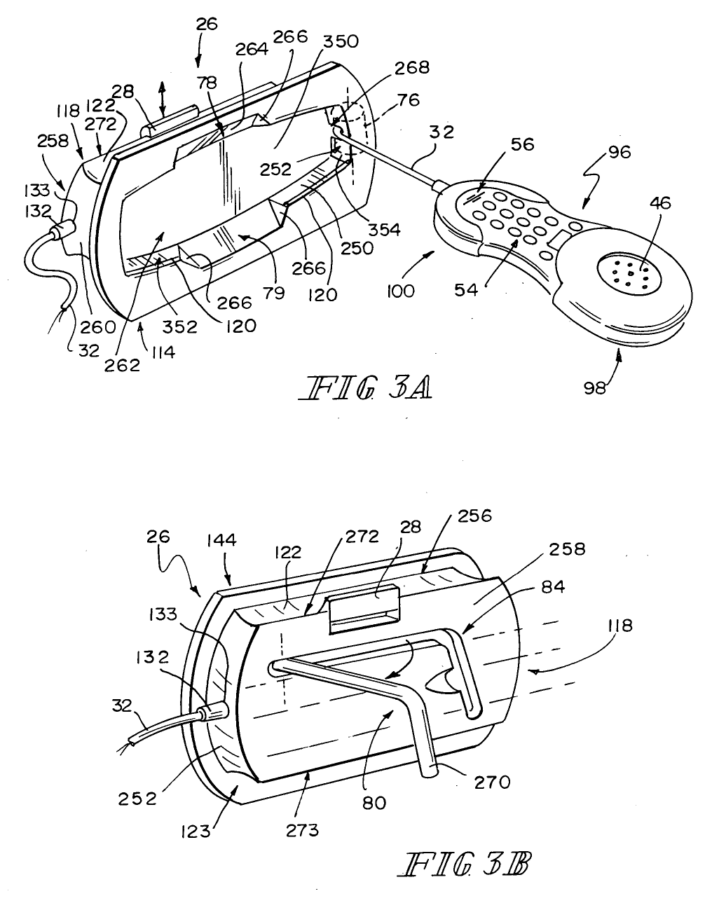

Referring to FIGS. 2, 3A, and 3B, holster 26 a body 118 which occupies a portion the siderail opening 116 and a flange 114 which extends beyond the siderail opening 116 to engage the siderail 18 when the holster 26 is positioned in the siderail opening 116. Flange 114 extends beyond the exterior periphery of body 118 and generally has a peripheral shape similar to the shape of the periphery of body 118. The back of body 118 has an upper concave surface 122, a lower concave surface 123, a left side surface 260, a right side surface 252, and a back surface 258. Concave surfaces 122, 123 have concavity following axes extending along the horizontal width of body 118. Concave surfaces 122, 123 are complementary to twp convex surfaces 128, 129 of the upper and lower portions of siderail opening 116. The front of body 118 has a cavity 262. A surface 350 that is internal to cavity 262 and at the back of cavity 262 is shaped to conform to the surface of the second side of pendant 20 comprising the telephone functions such that pendant 20 may only be stowed with patient-support apparatus function controls exposed. The interior surface (not shown) of upper side 256 and an interior surface 352 of lower side 250 are shaped to receive the exterior profile of pendant 20.

Flange 114 extends internally beyond a lower surface 352 and an upper side surface (not shown) of body 118 partially covering cavity 262 and forming a lip 120 which serves to retain pendant 20 when it is stowed in holster 26. Lip 120 is sized such that pendant 20 slips past lip 120 which flexes when stowing or removing force is placed on lip 120. Holster 26 has angled cut-outs 78 and 79 to permit gripping access by patient 70 to remove pendant 20 from holster 26. Angled cut-out 78 begins at the interior intersection of surface 350 and the upper side surface (not shown). A surface 264 is formed and extends at an angle obtuse to surface 350 until surface 264 intersects with flange 114. Angled cut-out 79 begins at the interior intersection of surface 350 and lower surface 352. A surface 265 is formed and extends at an angle obtuse to surface 350 until surface 264 intersects with flange 114. Angled cut-outs 78, 79 are horizontally centered in cavity 262 and have a width which is approximately one-third of the horizontal width of cavity 262. A right side surface 354 of cavity 262 has a passage 268 for cord 32 to pass from retraction mechanism 76 to pendant 20.

When holster 26 is placed into siderail opening 116, concave surfaces 122, 123 snap over convex surfaces 128, 129 resulting in a removable and slidable coupling of holster 26 to siderail 18. As indicated by arrows 334 in FIG. 2, holster 26 is configured to slide within siderail opening 116 to a number of positions within the longitudinal length of opening 116. Body 118 is constructed of a material having sufficient flexibility to allow two edges 272, 273 to slip past convex surfaces 128, 129 providing retention of holster 26 in siderail opening 116. The freedom of movement of holster 26 in siderail opening 116 permits the sliding movement of holster 26 to adjust the position of holster 26 within siderail opening 116. To minimize unwanted movement, releasable latch 28 provides a positive engagement between holster 26 and siderail 18. Releasable latch 28 is biased to an engaged position pressing releasable latch 28 against convex surface 128 of siderail 18. Releasable latch 28 is retained in body 118 which has a cavity 130 to permit releasable latch 28 to pass below edge 272 of body 118 as holster 26 is inserted into siderail opening 116. The releasable latch 28 bias must be overcome to insert holster 26 into siderail 18.

Upon installation, an extension spring (not shown) forces the releasable latch 28 upward against convex surface 128 to provide positive engagement with the siderail 18. Holster 26 slides within siderail opening 116 when sufficient force is applied to holster 26 parallel to concave surfaces 122, 123 and convex surfaces 128, 129. In other embodiments, mating of concave surfaces 122, 123 to convex surfaces 128, 129 may be replaced by other complementary linear shapes which mate to facilitate linear sliding motion. In some embodiments, bias of latch 28 may be accomplished by other devices suitable for creating bias including torsion springs, releasable latch being a flexible member attached to body 118, or other biased constructions known to those of ordinary skill in the art. In still further embodiments, holster 26 does not slide relative to siderail 18 due to the coupling mechanism used, such as screws or rivets, for example, or due to holster 26 occupying substantially all of the opening or other holster-receiving space provided in siderail 18.

Body 118 has an internal passage (not shown) routing electrical cord 32 from a cord inlet 132 to retraction mechanism 76. A strain relief 132 is provided at the interface between cord 32 and body 118 adjacent inlet 133. Retraction mechanism 76 is retained in holster 26 by a right side wall 252 of cavity 262. When stowed, pendant 20 is retained behind lip 120. Angled cut-outs 78, 79 on holster 26 are positioned complementary to a grip area 96 on pendant 20. The internal perimeter of flange 114 is sized to match the external periphery of pendant 20 such that pendant 20 can only be stowed with electrical cord 32 positioned at the same end of holster 26 as retraction mechanism 76.

In an alternative embodiment, cord 32 further comprises a weight 242 which is coupled to cord 32 outboard of holster 26 and siderail 18 as shown in FIG. 2. In this embodiment, holster 26 does not have retraction mechanism 76, but rather, cord 32 extends through a passage (not shown) in holster 26. Weight 242 tends to pull slack in cord 32 through holster 26 when a user stows pendant 20. Also in this embodiment, an end of cord 32 spaced from pendant 20 plugs into a receptacle elsewhere on patient-support apparatus 10 or in the patient room.

Holster 26 has a hook 80, seen in FIGS. 2 and 3B, which is extendable from the back of holster 26 and is used as an alternative to placing holster 26 in siderail opening 116. Hook 80 pivots when moving between a use position, shown in FIG. 3B, and a storage position, shown in FIG. 2. Hook 80, when used, hooks over the top edge of siderail 18. Hook 80 is biased to a storage position by a torsion spring (not shown). When hook 80 is placed over a portion of a patient-support apparatus 10, such as a siderail 18, having a thickness smaller than hook 80 can accommodate in its fully extended position, then hook will pivot under the bias of the torsion spring to clamp the portion of the patient-support apparatus 10 between an end portion 270 of hook 80 and back side 258 of pendant 20. Holster 26 has a cavity 84 in back surface 258 adapted to receive hook 80 when in the storage position. Cord 32 extends from holster 26 to interface box 112 where telephone signals are split from patient-support apparatus 10 controller signals.

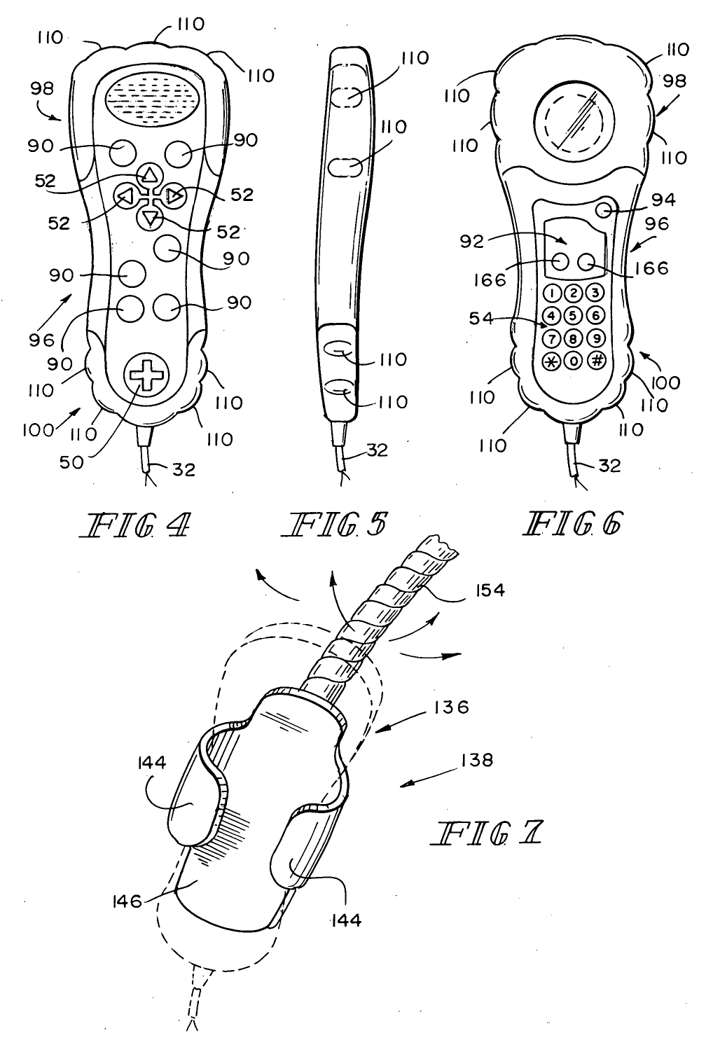

Referring now to FIGS. 3A, 4, and 6, pendant 20 is contoured in shape with a grip area 96, a speaker area 98, and a mouthpiece area 100. Pendant 20 further comprises two sides wherein a first side 86 has user input devices associated with bed control functions and a second side 88 has user input devices associated with telephone functions. The overall shape of pendant 20 provides an intuitive feel for the orientation of the device in use. Pendant 20 further comprises plurality nodules 110 which protrude from the perimeter of pendant 20. Nodules 110 provide a discontinuous edge surface to absorb shock and provide improved gripping of the pendant 20. The outer housing of pendant 20 is constructed of plastic in some embodiments, although any material(s) of suitable strength may be used.

First side 86 further comprises a speaker 46, function buttons 90, selector buttons 52, and a nurse call button 50. Function buttons 90 are selectable, such as by pressing, to choose a function of the bed to be operated. In the illustrative embodiment, functions include control of the height of patient-support apparatus 10 and articulation functions of patient-support apparatus 10 including head elevation and knee elevation. In other embodiments, functions controlled may include other patient controlled devices such as television channel up, channel down, volume up, volume down, radio, audio, direct lighting, or indirect lighting. Selector buttons 52 permit the user to provide input to the selected function. For example, if the television function is selected, selector buttons 52 will alter channel and volume settings on the television. Nurse call button 50 is used by patient 70 to engage communication with caregiver staff at a location remote from the patient room 38. Selector buttons 52, function buttons 90, and nurse call button 50 are all back-lit to improve visibility of the respective buttons in low light situations and include raised areas to improve locating of the buttons by tactile feel, and provide an auditory feedback that the button has been activated. While certain functions are described herein, a person of skill in the art will appreciate that there are many other functions not listed herein which may be controlled by pendant 20.

Audio signal from remote staff, television, or radio are communicated to patient 70 by speaker 46. Patient 70 uses microphone 56 to speak to caregiver staff that is remote to the patient room 38. Second side 88 of pendant 20 comprises a telephone. Second side 88 has a speaker 164, a microphone 168, a keypad 54, a display 92, function buttons 166, and dial button 94. Speaker 164 delivers audio to patient 70 from the telephone. Patient 70 speaks into the telephone through microphone 168. Keypad 54 is used to enter telephone numbers to be dialed. Display 92 provides a visual display of the number dialed by patient 70. Additionally, display 92 displays caller ID information and text to patient 70 as appropriate. Function buttons 166 provide additional menu driven functionality with the menu choices displayed on display 92. Dial button 94 dials the number entered into the telephone and displayed on display 92. Dial button 94 is also used to disconnect telephone connections when the call is complete. Key pad 54, display 92, function buttons 166, and dial button 94 are all back-lit to improve visibility of the respective buttons in low light situations and include raised areas to improve locating of the buttons by tactile feel, and provide an auditory feedback that the button has been activated.

Another embodiment, shown in FIGS. 8, 9, and 10, comprises a support structure 40 with a first end 134 coupled to a mounting bar 66 and a second end 136 coupled to a holster 138, with mounting bar 66 coupled to a device such as a patient-support apparatus 10, a chair 60, or an overbed table 62. Mounting bar 66 is coupled to the device. Illustratively, mounting bar 66 is coupled to a head section of apparatus 10 as shown in FIG. 8, to an arm 336 of chair 60 as shown in FIG. 9, and to an end of table section 338 of overbed table 62. First end 134 is coupled to mounting bar 66 by a clamp 64 lockable on mounting bar 66 in a plurality of positions. Support structure 40 is adjustable to position second end 136 in a plurality of positions. Holster 138 is coupled to second end 136.

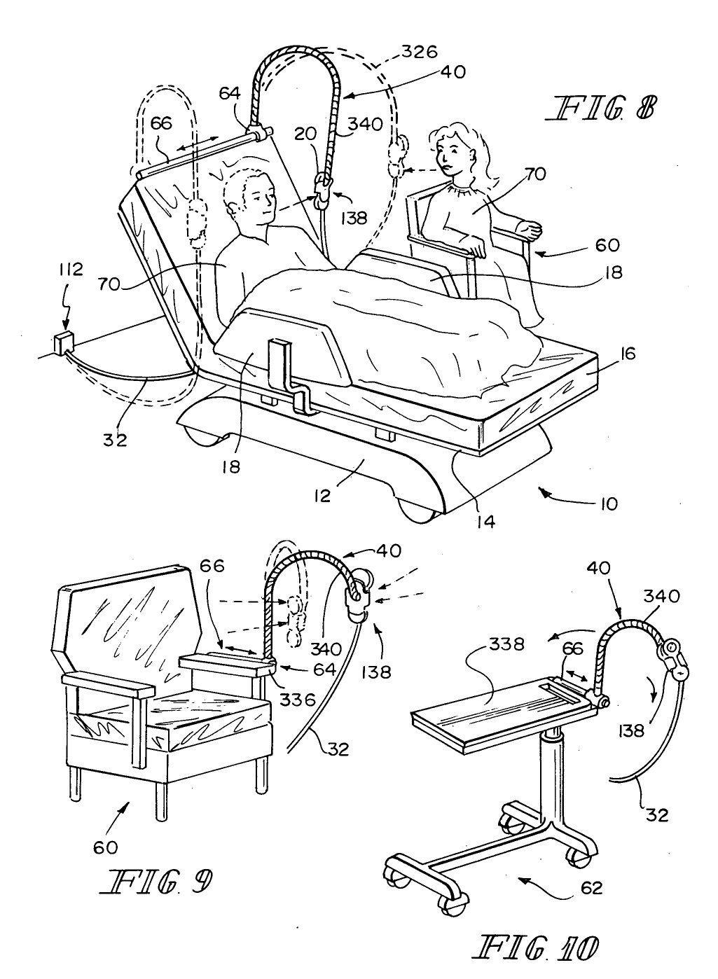

Holster 138 is configured to receive a pendant 20 as shown in FIG. 7. Holster 138 comprises two opposing arms 144 on each side, the arms curving around from the back 146 of holster 138. Arms 144 are spaced such that pendant 20 (shown in phantom) is cradled in the arms 144 and top edges of arms 144 engage speaker area 98 to support pendant 20. An electrical cord 32 is coupled to pendant 20 and fits between arms 144 as pendant 20 is placed in holster 138. As pendant 20 cradles in holster 138, pendant 20 is removable by patient 70 as necessary. An opposite end of electrical cord 32 is coupled to an interface box 112 which splits the telephone signal from the controller signal and further conducts the signal to each appropriate device. Support structure 40 is coupled to clamp 64.

Support structure 40 comprises a flexibly positionable gooseneck member 340. Referring to FIG. 8, support structure 40 is movable between a first position (in solid) on a left side of apparatus 10 and a second position (in phantom) on a right side of apparatus 10. The gooseneck member 340 of support structure 40 can be moved relative to clamp 64 to a number of configured positions. Clamp 64 is moveable to a number of positions along mounting bar 66 and is lockable to fix support structure 40 in any desired position between the first and second positions. Second end of support structure 40 may be positioned on either side of patient-support apparatus 10, or may be positioned such that patient 70 can access pendant 20 while sitting in a chair 60 adjacent to patient-support apparatus 10. FIG. 9 illustrates the same structure 40 attached directly to chair 60, providing flexibility of positioning within the patient room with a first position shown in solid and a second position shown in phantom. Flexible positioning of pendant 20 allows patient 70 to access pendant 20 throughout the room.

FIG. 10 further illustrates support structure 40 coupled to overbed table 62. In this configuration, support structure 40 can be moved to different areas of the room with relative ease, permitting the pendant 20 to be positioned near a chair 60 or near a patient-support apparatus 10 as required in the particular circumstance. In this embodiment, electrical cord 32 is coupled to an interface box 112. In an alternative embodiment, electrical cord 32 may be coupled to patient-support apparatus 10 and the signals split within patient-support apparatus 10. While the illustrated embodiment shows interface box 112 mounted to a wall, it is contemplated that interface box may be located anywhere within a room as required to manage routing electrical cord 32. In another embodiment, electrical cord 32 is routed through support structure 40.

In still another embodiment, a support arm 150 is coupled to a structure 42 that is attached to a wall 148 of a hospital room as shown in FIG. 11. Support arm 150 comprises a first end 134 moveable to a plurality of positions along structure 42 and a second end 136 moveably positionable to a plurality of points in space. Support arm 150 further comprises a rigid portion 152 and a flexible portion 154. Rigid portion 152 extends out away from structure 42. Support arm 150 is coupled to structure 42 by a plate 160 which is retained in track 162 of structure 42. Arm 150 is pivotable about axis 330 relative to plate 160. Track 162 supports plate 160 which, in turn, supports arm 150. Plate 160 is moveable horizontally in track 162 permitting adjustment of the position of support arm 150 relative to patient 70. Holster 138 is coupled to second end 136. Flexible portion 154 is mechanically coupled to rigid portion 152. Flexible portion 154 is a flexibly positionable gooseneck member which permits holster 138 to be rotated and repositioned to vary the orientation of holster 138 and pendant 20. While FIG. 11 shows structure 40 adjacent to patient-support apparatus 10, this structure 40 may be used adjacent to any location where a patient 70 or caregiver may find it useful. Holster 138, as described above, permits pendant removal by patient 70.

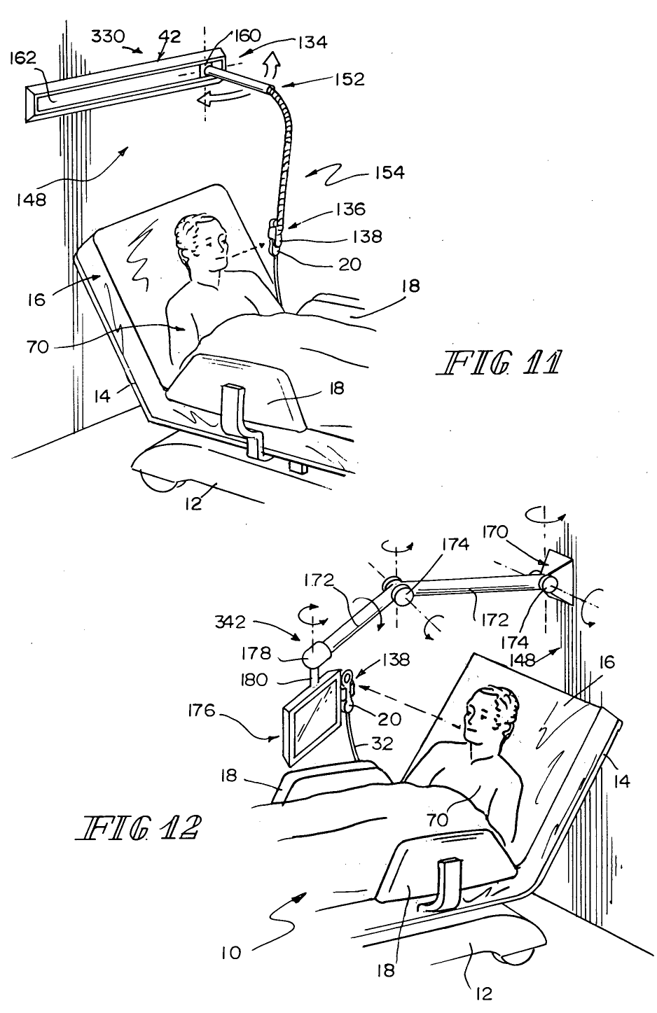

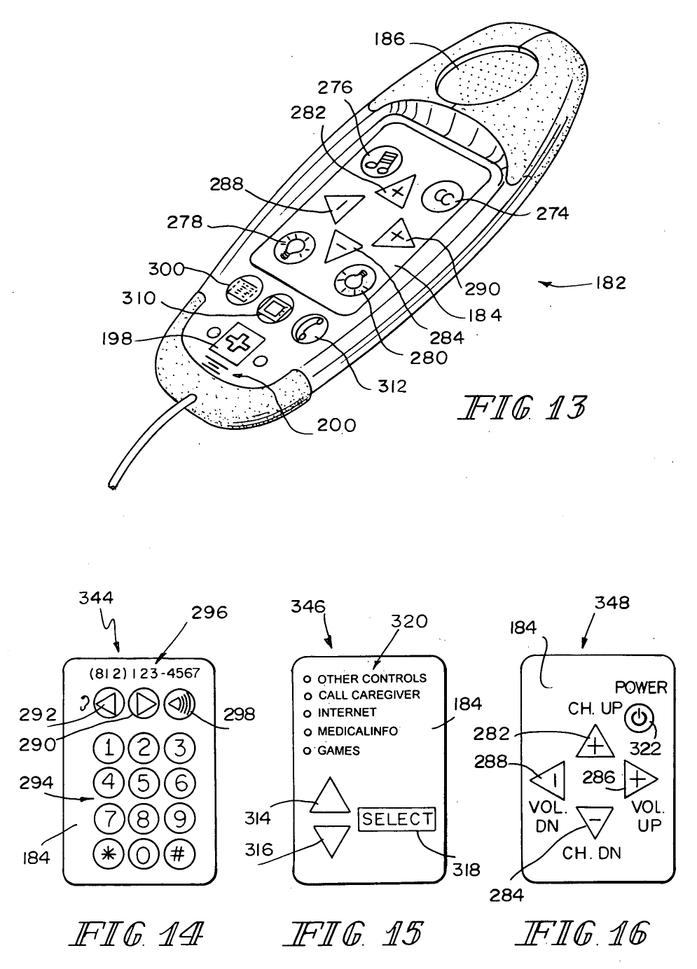

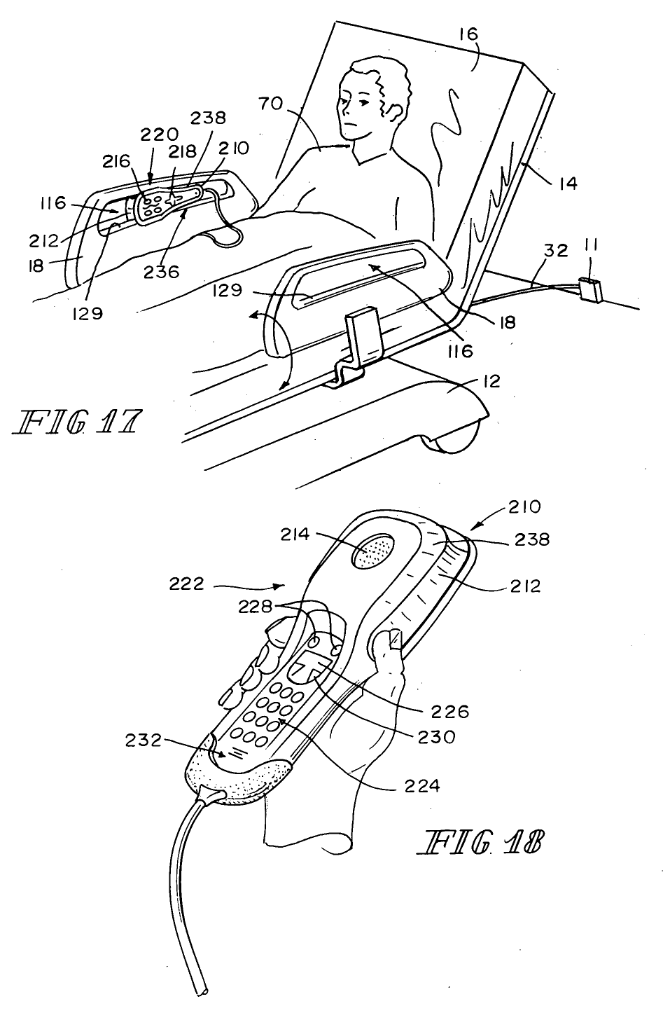

In another embodiment, holster 138 is coupled to a video display 176 as is shown in FIG. 12. Video display 176 is supported by a structural system 342 comprising a mount 170 coupled to a wall 148. A universal coupler 174 is attached to mount 170, wherein universal coupler 174 pivots in a plurality of directions. An arm 172 is attached to universal coupler 174 at a first end of arm 172 opposite mount 170. A second universal coupler 174 is attached to arm 172 at a second end of arm 172. A second arm 172 is attached to second coupler 174 at a first end of the second arm 172. A cap 178 is coupled to a second end of second arm 172. A hanger 180 is pivotably coupled to cap 178 and hanger 180 is configured to support video display 176. The resulting system permits positioning of video display 176 in a plurality of positions relative to wall 148 with video display 179 orientable in a plurality of angles relative to patient 70. Holster 138 is coupled to video display 176. As discussed in previous embodiments, holster 176 is configured to receive pendant 20. While FIG. 12 shows structural system 342 adjacent to patient-support apparatus 10, this structural system 342 may be used adjacent to any location where a patient 70 or caregiver may find it useful. Additionally, structural system 342 has mount 170 coupled to wall 148. In alternative embodiments, mount 170, may couple to any structure capable of supporting the load of video display 176. The structural system may have plurality universal couplers 174 and plurality arms 172 as is required to accomplish the configuration desired and this disclosure should not be construed to be limited to two arms 172 and two couplers 174.

FIG. 13 illustrates yet another embodiment, wherein a pendant 182 functioning as both a telephone and a controller for one or more functions of a patient-support apparatus 10, comprises a touchscreen display 184, a speaker 186, a microphone 200, hard function keys for menu 300, television 310, telephone 312, and nurse call 198. Pendant 182 provides multiple functions to a user from a single user interface. Touchscreen 184 is a liquid crystal display (LCD) in the illustrative embodiment. Other types of touchscreens may be used if desired. Touchscreen display 184 provides a menu driven interface, including at least a telephone keypad/display shown in FIG. 14, a plurality of menu screens as shown in FIG. 15, and a control screen as shown in FIG. 16. Pendant 182 has a similar shape as pendant 20 and interfaces with holsters 26 and 138 in a similar fashion to pendant 20. Functions available to be controlled from pendant 182 include at least one function of a patient-support apparatus 10. Additionally, radio, television, lighting, audio, games, internet access, and other similarly useful functions may be controlled from pendant 182.

Function keys are programmed to activate a particular menu on touchscreen display 184 to eliminate the need to scroll through several menus to utilize a particular function. Function keys in this embodiment are a bed function key 300, television key 310, and telephone key 312. The bed function key activates a touchscreen menu which allows the user to manipulate various patient-support apparatus 10 functions by touching appropriate fields of the touchscreen. The television key 310 activates a screen on display 184 (shown in FIG. 13) which allows the user to control television functions by touching any of the following fields appearing on touchscreen 184: volume up 290, volume down 288, channel up 282, channel down 284, closed captioning 274, radio 276, indirect lighting 278 and direct lighting 280. The telephone key activates a menu which allows the pendant to function as a telephone with touchscreen display 184 serving as an integrated telephone keypad/display as shown in screen 344 of FIG. 14. The telephone function includes touchscreen fields for volume up 290, volume down 292, a keypad 294, number display 296, and a ringer control 298.

FIG. 15 shows an alternative menu screen 346 on display 184 to be used to access information and entertainment. In the configuration shown in screen 346, touchscreen display 184 provides a navigable menu display with a navigate-up user input 314, a navigate-down user input 316, a select user input 318, and a menu display 320. A user navigates through a series of menus by selecting the appropriate item to be taken to another screen. FIG. 16 shows a simplified television control screen 348. On screen 348, only television controls are displayed including channel up 282, channel down 284, volume up 286, volume down 288, and power 322. Screen 348 provides a simple and easy to use interface for a user. It is contemplated that other functions may be utilized through the function key approach in alternative embodiments. In yet another embodiment, the function keys are programmable by a user to activate particular functions as preferred by that user.

A person having skill in the art will appreciate the various screens and functionality that may be programmed into pendant 182 beyond those which are described herein. For example, in some embodiments, pendant 182 operates as a television display screen. Some embodiments of pendant 182 include a menu function which displays a television program guide from which the user can select a program to be viewed without having to cycle through several channels to determine what programs are available. In some embodiments, display 184 may serve as a cursor control for on-screen television menus and displays. Some embodiments include games accessible by the patient as a form of entertainment.

In some embodiments, display 184 provides interactive communication with the patient regarding hospital services. For example, in some embodiments the patient reviews food service options and chooses meal items via pendant 182. Some embodiments display the schedule of services for the patient such as physical therapy, speech therapy, tests to be run, timing of physician rounds, radiological services, blood draws, medication schedules, and the like. Some embodiments provide information to the user in the form of medical definitions and descriptions of procedures. In some embodiments, this may include video of procedures. In some embodiments, this may include narrated video of presentations on procedures and conditions.

In some embodiments, pendant 182 communicates with the patient-support apparatus 10 and provides interactive diagnostics for a service technician. This may include: information on electrical system components, trouble codes, an electronic service manual, a parts list, apparatus model number, apparatus serial number and/or apparatus manufacture date. In some embodiments, pendant 182 includes a service log whereby service to the apparatus is recorded for future reference.

In some embodiments, pendant 182 provides interactive communication between a patient and nursing staff. This includes a prioritized nurse call system allowing the patient to choose from a list of reasons why caregiver assistance is requested. Reasons listed include: pain relief needed, restroom assistance needed, question, linen assistance needed, equipment alarm is sounding, and the like. Some embodiments include a 2-way camera with a camera mounted to pendant 182 such that the patient and caregiver can see each other while communicating through the nurse call system.

In some embodiments, pendant 182 provides interactive assistance with patient care. For example, in some embodiments pendant 182 communicates with an automated medication delivery system, prompting the patient to enter a password when medication is due and deliver the medication after the correct password has been entered. In some embodiments, pendant 182 recognizes a patient or caregiver fingerprint and automatically delivers the medication upon proper authorization by the patient or caregiver. In still other embodiments, pendant 182 prompts a patient to respond to a motor-sensory response test which stimulates the patient and evaluates patient response as a measure of patient motor-sensory functioning.

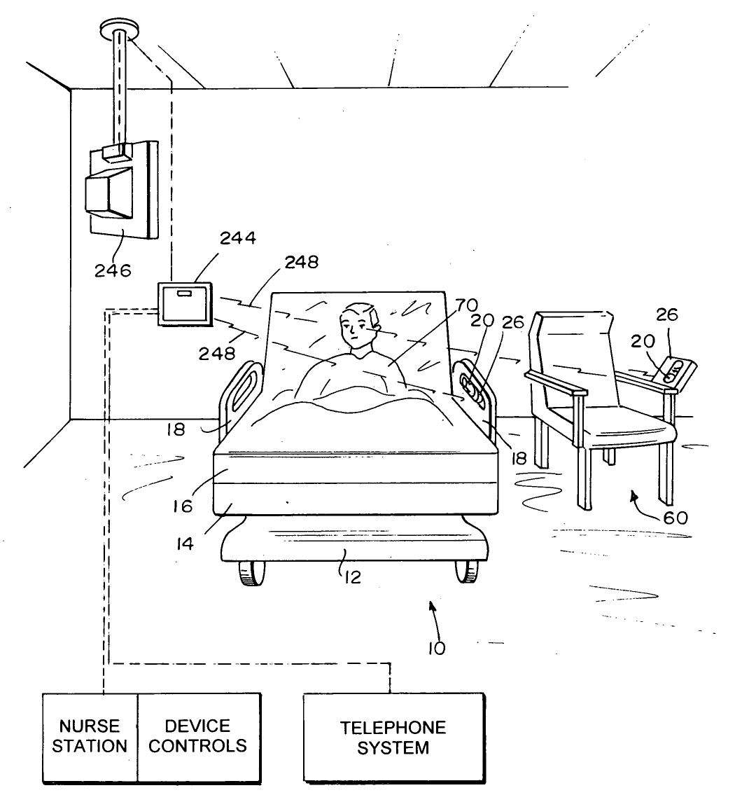

In still another embodiment, shown in FIGS. 17 and 18, a pendant 210 operating as both a telephone and a controller of at least one function of a patient-support apparatus 10, comprises a first side 220, a second side 222, a grip area 236, a concave edge surface 212, and a cover 238. First side 220 further comprises plurality function keys 216 operating at least one patient-support apparatus 10 articulation function, a plurality of selector keys 218, and a nurse call button 234. Second side 222 further comprises a speaker 214, a microphone 232, a keypad 224, a display 226, a dial button 228, and a plurality of phone selector keys 230. Concave edge surface 212 is configured to interface with convex surfaces 128, 129 of siderail 18. Cover 238 allows pendant 210 to be snapped into siderail 18 and retained through an interference fit between cover 238 and siderail 18. The fit is further enhanced through the mating of concave surface 212 and convex surfaces 128, 129. Cover 238 further comprises a grip area 236 at a cord end 240 of pendant 210. Grip area 236 has a reduced width and rounded contour at cord end 240.

First side 220 has a controller for articulation functions of patient-support apparatus 10 and other devices in the patient room. The other devices controlled include television volume up and down, television channel up and down, radio, audio, direct lighting and indirect lighting. Second side 222 provides a user the functionality of a standard telephone. Included are keypad 224, a redial button 324, display 226, phone selector keys 230, speaker 214, and microphone 232 similar to telephone embodiment described above. Pendant 210 is configured so that when attached to siderail 18, only first side 220 faces toward the patient to present the bed function keys 216 to the patient. Orientation of pendant 210 in siderail 18 is accomplished by having cover 238 shaped so that pendant 210 can only snap into siderail with first side 220 exposed.

In some embodiments pendants 20, 182, 210, are substantially waterproof. In other embodiments, pendants 20, 182, 210 further comprise a transparent sanitary cover (not shown). The sanitary cover is removable and is intended to be patient specific so as to reduce potential for cross contamination and reduce time to clean between patients. The sanitary cover also includes anti-microbial agents in the materials selected. In some embodiments, the sanitary cover may be transparent. Some embodiments of pendants 20, 182, 210 utilize membrane switch technology to create single surface over all user inputs. The integrated user inputs improve cleanability of the user inputs.

Embodiments of pendants 20, 182, 210 may integrate additional technology into the telephone operation. Some embodiments will disable controller functionality on the opposite side of the pendant when the telephone is powered to prevent bed movement while the pendant is being operated as a phone. Some embodiments will operate as both a standard telephone and a speakerphone. Some embodiments will allow incoming calls to be redirected to receive a message that the patient is not receiving calls. Some embodiments will automatically mute television or radio audio when the telephone is answered. Some embodiments will flash LEDs when a call is incoming and the ringer is turned off.

Alternative embodiments of pendants 20, 182, 210 have wireless coupling to a wireless receiver 244 as shown in FIG. 19. Pendant 20, 182, or 210 sends a wireless signal 248 when patient 70 makes an input. The wireless receiver 244 processes the wireless signal 248 and routes the signal to the appropriate system such as the nurse station, device controls, or telephone system. In this embodiment, wireless signal 244 is a radio frequency (RF) signal. In another embodiment, the wireless signal 244 may be infra-red (IR). In the wireless embodiment, the need for electrical cord 32 is eliminated. This increases the mobility of pendant 20, 182, or 210.

Although certain illustrative embodiments have been described in detail above, variations and modifications exist within the scope and spirit of this disclosure as described and as defined in the following claims.

1. A patient-support apparatus, the apparatus comprising
a frame,
a siderail coupled to the frame,
a hand-held pendant functioning as both a telephone and a controller to receive user inputs that control at least some patient-support apparatus functions; and
a holster coupled to the siderail and moveable to a plurality of positions on the siderail, the holster being configured to hold the pendant until removed by a user.

2. The patient-support apparatus of claim 1, wherein the pendant is substantially waterproof.

3. The patient-support apparatus of claim 1, wherein the pendant further comprises an electrical cord which couples the pendant to the patient-support apparatus.

4. The patient-support apparatus of claim 3, wherein the electrical cord is retractable.

5. The patient-support apparatus of claim 1, wherein the pendant further comprises a wireless connection which couples the pendant to the patient-support apparatus.

6. The patient-support apparatus of claim 1, wherein the pendant further comprises a touchscreen user interface.

7. The patient-support apparatus of claim 1, wherein the pendant is configured to disable control of the patient-support apparatus when the telephone is in use.

8. The patient-support apparatus of claim 1, where in the pendant is configured to mute television and other audio when the telephone is answered.

9. A communication and control apparatus for use by a person in a patient room having a patient-support apparatus therein, the communication and control apparatus comprising
a hand-held pendant functioning as both a telephone and a controller to receive user inputs that control at least some patient-support apparatus functions,
a support adjustable to a plurality of positions coupled to the patient-support apparatus; and
a holster coupled to the support, the holster being configured to hold the pendant until removed by a user.

10. The communication and control apparatus of claim 9, wherein the pendant is substantially waterproof.

11. The communication and control apparatus of claim 9, wherein the pendant further comprises an electrical cord which couples the pendant to the patient-support apparatus.

12. The communication and control apparatus of claim 9, wherein the cord is retractable.

13. The communication and control apparatus of claim 12, wherein the electrical cord passes through the support.

14. The apparatus of claim 9, wherein the pendant further comprises a wireless connection which couples the pendant to the patient-support apparatus.

15. The communication and control apparatus of claim 9, wherein the pendant further comprises a touchscreen user interface.

16. The communication and control apparatus of claim 9, wherein the pendant is configured to disable control of the patient-support apparatus when the telephone is in use.

17. The communication and control apparatus of claim 9, where in the pendant is configured to mute television and other audio when the telephone is answered.

18. A communication and control apparatus for use by a person in a patient room having a patient-support apparatus therein, the communication and control apparatus comprising
a hand-held pendant functioning as both a telephone and a controller to receive user inputs that control at least some patient-support apparatus functions, the hand-held pendant having a touchscreen user input that displays a first screen for bed control and a second screen for telephone control.

19. The communication and control apparatus of claim 18, wherein the pendant is configured to disable control of the patient-support apparatus when the telephone is in use.

20. The communication and control apparatus of claim 18, where in the pendant is configured to mute television and other audio when the telephone is answered.

21. A communication and control apparatus for use by a person in a patient room having a structure and a patient-support apparatus therein, the communication and control apparatus comprising
a hand-held pendant functioning as both a telephone and a controller to receive user inputs that control at least some patient-support apparatus functions,
a support adjustable to a plurality of positions adapted to be coupled to a structure in the patient room; and
a holster coupled to the support, the holster being configured to hold the pendant until removed by a user.

22. The communication and control apparatus of claim 21, wherein the pendant is substantially waterproof.

23. The communication and control apparatus of claim 21, wherein the pendant further comprises an electrical cord which couples the pendant to the patient-support apparatus.

24. The communication and control apparatus of claim 21, wherein the cord is retractable.

25. The communication and control apparatus of claim 24, wherein the electrical cord passes through the support.

26. The apparatus of claim 21, wherein the pendant further comprises a wireless connection which couples the pendant to the patient-support apparatus.

27. The communication and control apparatus of claim 21, wherein the pendant further comprises a touchscreen user interface.

28. The communication and control apparatus of claim 21, wherein the pendant is configured to disable control of the patient-support apparatus when the telephone is in use.

29. The communication and control apparatus of claim 21, where in the pendant is configured to mute television and other audio when the telephone is answered.
